(19) United States
(12) Patent Application Publication
(10) Pub. No.: US 2024/0354352 A1
(43) Pub. Date: Oct. 24, 2024

(54) METHODS AND SYSTEMS FOR RECOMMENDING REGION SPECIFIC PERSONALIZED NEWS

(71) Applicant: JIO PLATFORMS LIMITED, Ahmedabad (IN)

(72) Inventors: Amit SACHAN, Bangalore (IN); Juhi TANDON, Kolkata (IN)

(73) Assignee: JIO PLATFORMS LIMITED, Ahmedabad (IN)

(21) Appl. No.: 18/713,793

(22) PCT Filed: Nov. 24, 2022
(86) PCT No.: PCT/IB2022/061377

§ 371 Date: May 28, 2024

(30) Foreign Application Priority Data
Nov. 26, 2021 (IN) 202121054662

(51) Int. Cl. G06F 16/9537; G06F 16/9535

(52) U.S. Cl. CPC G06F 16/9537; G06F 16/9535

(57) ABSTRACT

Present disclosure generally relates to information aggregation and recommendation systems, particularly to methods and systems for recommending region specific personalized news. System fetches articles from various publishers, aggregates and curate articles in various languages. System identifies entities in news article, determines importance of location entity in news article using evidence from various textual parts of content and position of textual parts in articles. System resolves ambiguity in determining location associated with event of news article from plurality of location present in news articles, using meta data such as markers in URL, using attribute and predicate based relationships with other extracted entities extracted from enterprise centric Knowledge Graph. System assigns locality sensitivity score to each news article and determines ordered list of language prevalence for location to granularity of pin code etc., based on user consumption. System attenuates ranking of recommendation for geographic locale-based on language and corresponding publisher affinity.

### FIELD OF INVENTION

The embodiments of the present disclosure generally relate to information aggregation and recommendation systems. More particularly, the present disclosure relates to methods and systems for recommending region specific personalized news.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In general, local publishing houses may be moderately disappearing, due to which local stories may be lost and causes many geographic locations to be news deserts. Under representation of native content in native language may cause a sense of alienation among users. When local journalism declines and the consumption of these stories experience a free-fall, it dwindles the responsibility of the media. Local stories are known to be more trustworthy, unbiased and concerning welfare of the community. These stories may be important to highlight local events such as disasters, accident, crime, and the like.

Conventional techniques may disclose a local news tab which shows headlines personalized by user location. The application prioritizes neighbourhood news followed by news from the next-largest administrative area. Another conventional technique includes reporting by local news organizations rather than national news organizations. These findings played a role in the decision to build a dedicated local news tab. Another conventional technique discloses search out and aggregate, news content published on web. Another conventional system and method permit geographically pertinent information to be ranked by users according to users' geographic proximity to information and to each other for affecting the ranking of such information. Yet another conventional method identifies and ranks news sources.

However, conventional techniques may have less coverage for a smaller location other than metro location. The content may not be sorted on recency, and may have articles from a few months ago. Further, conventional techniques may require user input to choose cities or pin code to follow. The conventional techniques may map the given pin code to the respective city and not to specific region. Mostly, the conventional techniques may provide articles in which location or state is mentioned in headlines and may not have a high recall to provide articles where location mentioned in full text or reporting line. The conventional techniques may not be able to judge any specific ranking scheme or order. Further, only wide spoken languages are only well represented.

There is therefore a need in the art to provide methods and systems for recommending region specific personalized news, that can overcome the shortcomings of the existing prior art and exudes social responsibility by turning attention towards region specific news to promote civic engagement and by making smallest locations well represented and the authorities more accountable. Further, there is a need for shortcomings of the existing prior art by recommending regional content to users in almost all scheduled languages including subcontinent languages.

### OBJECTS OF THE PRESENT DISCLOSURE

Some of the objects of the present disclosure, which at least one embodiment herein satisfies are as listed herein below.

An object of the present disclosure is to provide methods and systems for recommending region specific personalized news.

An object of the present disclosure is to provide tagging of news articles as local to a geographic location.

An object of the present disclosure is to enable named entity tagging and Knowledge Graph (KG) based relatedness measures to determine the location of news event from a plurality of location mentions.

An object of the present disclosure uses Knowledge Graph (KG) to find location and other entities (such as city, person and the like) using canonical/surface form.

An object of the present disclosure is to provide methods and systems for determining location importance to news article based on position of mention in text and user feedback.

An object of the present disclosure is to enable language and publishers as factors to decide local importance of news articles.

An object of the present disclosure is to provide methods and systems to recommend local news in a plethora of subcontinent/local languages catering to linguistic and community sentiment.

An object of the present disclosure is to provide personalised local news content according to deep analysis of user profile.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure provides for a system for recommending region specific personalized news. The system may include one or more processors operatively coupled to a plurality of first computing devices, the one or more processors coupled with a memory that stores instructions which when executed by the one or more processors may cause the system to receive one or more content inputs from the plurality of first computing devices, the one or more content inputs pertaining to one or more news articles and receive a plurality of user inputs from the plurality of first computing devices, the plurality of user inputs pertaining to interest of the plurality of users with the one or more news articles. The system may be configured to extract a first set of attributes from the received one or more content inputs, the first set of attributes pertaining to one or more contextual parameters associated with the one or more content inputs and extract a second set of attributes from the received one or more content inputs, the second set of attributes pertaining to geographical location associated with the one or more contextual parameters. The system may extract a third set of attributes from the received one or more content inputs, the third set of attributes pertaining to language of the one or more articles associated with the plurality of news. Based on the extracted first, second, third set of attributes and the received plurality of user inputs, the system may determine, a locality sensitivity score to each news article. The system may be further configured to rank, the one or more content inputs in an ordered list based on the locality sensitivity score and then auto-recommend, the ordered list to a plurality of users associated with the plurality of first computing devices.

In an embodiment, the one or more contextual parameters may include granular details of a location, language, category, topic, publisher preference, preferred entities such as popular people associated with the one or more news articles.

In an embodiment, the system may be further configured to determine a publisher affinity to a geographic location associated with the one or more news articles.

In an embodiment, the system may be further configured to determine, by a knowledge graph module, the ordered list based on a language, predicate, attribute, prevalence of a location, the location comprising a granularity of pin code, city, district based on user consumption of language specific news articles.

In an embodiment, the system may be further configured to attenuate ranking of the ordered list for a geographic locale based on language and the publisher affinity. The ordered list may be provided, without any change to one or more new users on receiving queried location from one or more first computing devices associated with the one or more new users.

In an embodiment, the system may be further configured to personalise the ordered list to one or more existing users based on an existing user transaction data associated with a user profile received from one or more first computing devices associated with the one or more existing users.

In an embodiment, the system may be further configured to determine geographic relevance of the one or more news articles that is being read in a location by a plurality of users.

In an embodiment, the system may be further configured to determine impact of position of location in the one or more news articles on importance of the one or more news articles, and further determine if the article is local to a location, is of national importance or needs international coverage.

In an embodiment, the system may be further configured to generate one or more news articles pertaining to a specific geographic location based on the received plurality of user inputs associated with the specific geographic location.

In an embodiment, the system may be further configured to: resolve ambiguity in determining location associated with an event of the news article from a plurality of locations that are present in the news articles and further prune one or more irrelevant recommended one or more content inputs and reorder the one or more content inputs to the ordered list.

In an aspect, the present disclosure provides for auser equipment (UE) for recommending region specific personalized news. The UE may include a processor and a receiver operatively coupled to a plurality of first computing devices, the processor coupled with a memory that stores instructions which when executed by the processor may cause the UE to receive one or more content inputs from the plurality of first computing devices, the one or more content inputs pertaining to one or more news articles and receive a plurality of user inputs from the plurality of first computing devices, the plurality of user inputs pertaining to interest of the plurality of users with the one or more news articles. The UE may be configured to extract a first set of attributes from the received one or more content inputs, the first set of attributes pertaining to one or more contextual parameters associated with the one or more content inputs and extract a second set of attributes from the received one or more content inputs, the second set of attributes pertaining to geographical location associated with the one or more contextual parameters. The UE may extract a third set of attributes from the received one or more content inputs, the third set of attributes pertaining to language of the one or more articles associated with the plurality of news. Based on the extracted first, second, third set of attributes and the received plurality of user inputs, the UE may determine, a locality sensitivity score to each news article. The UE may be further configured to rank, the one or more content inputs in an ordered list based on the locality sensitivity score and then auto-recommend, the ordered list to a plurality of users associated with the plurality of first computing devices.

In an aspect, the present disclosure provides for a method for recommending region specific personalized news. The method may include the step of receiving, by one or more processors, one or more content inputs from the plurality of first computing devices, the one or more content inputs pertaining to one or more news articles. In an embodiment, the one or more processors may be operatively coupled to a plurality of computing devices and further coupled with a memory that may store instructions that may be executed by the one or more processors. The method may include the step of receiving, by the one or more processors, a plurality of user inputs from the plurality of first computing devices, the plurality of user inputs pertaining to interest of the plurality of users with the one or more news articles. The method may further include the step of extracting, by the one or more processors, a first set of attributes from the received one or more content inputs, the first set of attributes pertaining to one or more contextual parameters associated with the one or more content inputs and also extracting, by the one or more processors, a second set of attributes from the received one or more content inputs, the second set of attributes pertaining to geographical location associated with the one or more contextual parameters. Furthermore, the method may include the step of extracting, by the one or more processors, a third set of attributes from the received one or more content inputs, the third set of attributes pertaining to language of the one or more articles associated with the plurality of news. Based on the extracted first, second, third set of attributes and the received plurality of user inputs, the method may include the step of determining, by the one or more processors, a locality sensitivity score to each news article and then the step of ranking, by the one or more processors, the one or more content inputs in an ordered list based on the locality sensitivity score. Furthermore, the method may include the step of auto-recommend, by the one or more processors, the ordered list to a plurality of users associated with the plurality of computing devices.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an exemplary network architecture in which or with which proposed system of the present disclosure can be implemented, in accordance with an embodiment of the present disclosure.

FIG. 2A illustrates an exemplary block diagram representation of proposed system for recommending region specific personalized news, in accordance with an embodiment of the present disclosure.

FIG. 2B illustrates an exemplary block diagram representation of a user equipment (UE) for recommending region specific personalized news, in accordance with an embodiment of the present disclosure.

FIG. 3A illustrates exemplary block diagram representation of a proposed system architecture, in accordance with an embodiment of the present disclosure.

FIG. 3B illustrates an exemplary schematic diagram representation of recommending region specific personalized news, in accordance with an embodiment of the present disclosure.

FIGS. 4A and 4B illustrate flow diagram representations of method to determine affinity of other entities to a location entity in phase 1 and phase 2 respectively, in accordance with an embodiment of the present disclosure.

FIG. 4C illustrates a flow diagram representation of method to determine geographic relevance of entities for users, in accordance with an embodiment of the present disclosure.

FIG. 4D illustrates a flow diagram representation of method for determining impact of position of location mention in news articles on location importance, in accordance with an embodiment of the present disclosure.

FIG. 4E illustrates a flow diagram representation of method to determine geographic relevance of a language, in accordance with an embodiment of the present disclosure.

FIG. 4F illustrates a flow diagram representation of method to rank articles from a set of candidate articles for a given location, in accordance with an embodiment of the present disclosure.

FIG. 5 illustrates an exemplary computer system in which or with which embodiments of the present invention can be utilized, in accordance with embodiments of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Embodiments of the present disclosure provides methods and systems for recommending region specific personalized news. The present disclosure enables named entity tagging and Knowledge Graph (KG) based relatedness measures to determine the location of news event from a plurality of location mentions. The present disclosure uses Knowledge Graph (KG) to find location and other entities (such as city, person and the like) using canonical/surface form. The present disclosure provides methods and systems for determining location importance to news article based on position of mention in text and user feedback. The present disclosure enables language and publishers as factors to decide local importance of news articles. The present disclosure provides methods and systems to recommend local news in a plethora of subcontinent/local languages catering to linguistic and community sentiment. The present disclosure provides personalised local news content according to deep analysis of user profile.

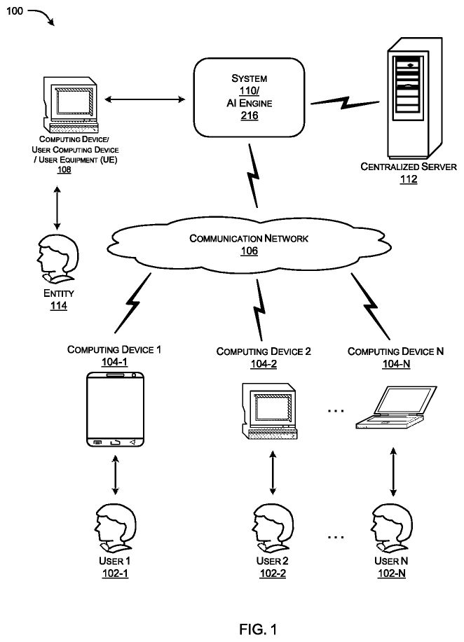

Referring to FIG. 1 that illustrates an exemplary network architecture for a region-specific personalized news recommendation system (100) (also referred to as network architecture (100)) in which or with which a system (110) or simply referred to as the system (110) of the present disclosure can be implemented, in accordance with an embodiment of the present disclosure. As illustrated, the exemplary architecture (100) may be equipped with the system (110) for recommending region specific personalized news to users (102-1, 102-2, 102-3 . . . 102-N) (individually referred to as the user (102) and collectively referred to as the users (102)) associated with one or more first computing devices (104-1, 104-2 . . . 104-N) (individually referred to as the first computing device (104) and collectively referred to as the first computing devices (104)). The system (110) may be further operatively coupled to a second computing device (108) (also referred to as the user computing device or user equipment (UE) hereinafter) associated with an entity (114). The entity (114) may include a company, an organisation, a university, a lab facility, a business enterprise, a defence facility, or any other secured facility. In some implementations, the system (110) may also be associated with the UE (108). The UE (108) can include a handheld device, a smart phone, a laptop, a palm top and the like. Further, the system (110) may also be communicatively coupled to the one or more first computing devices (104) via a communication network (106). The network architecture (100) may include Artificial Intelligence (AI) engine (116).

The system (110) may be coupled to a centralized server (112). The centralized server (112) may also be operatively coupled to the one or more first computing devices (104) and the second computing devices (108) through the communication network (106). In some implementations, the system (110) may also be associated with the centralized server (112).

In an embodiment, the system (110) may receive one or more content inputs from the plurality of first computing devices (104). The one or more content inputs may pertain to one or more news articles. For example, the system (110) may fetch articles from various publishers, aggregates and curate articles in various languages.

In another embodiment, the system (110) may receive a plurality of user inputs from the plurality of first computing devices (104. For example, the plurality of user inputs may pertain to interest of the plurality of users with the one or more news articles.

The system (110) may then extract a first set of attributes from the received one or more content inputs. The first set of attributes may pertain to one or more contextual parameters associated with the one or more content inputs and then further extract a second set of attributes from the received one or more content inputs. The second set of attributes may pertain to geographical location associated with the one or more contextual parameters. The system (110) may further extract a third set of attributes from the received one or more content inputs, the third set of attributes pertaining to language of the one or more articles associated with the plurality of news. Based on the extracted first, second, third set of attributes and the received plurality of user inputs, the system (110) may then be configured to determine, a locality sensitivity score to each news article and thereby rank, the one or more content inputs in an ordered list based on the locality sensitivity score. Furthermore, the system (110) may be configured to auto-recommend, the ordered list to a plurality of users associated with the plurality of first computing devices (104).

In an embodiment, the system (110) may identify entities in the news article, determine importance of a location entity in the news article using evidence from various textual parts of content and position of the textual parts in the articles.

In an embodiment, the system (110) may resolve ambiguity in determining location associated with the event of the news article from a plurality of location that may be present in the news articles, using meta data such as markers in URL, using attribute and predicate based relationships with other extracted entities extracted from enterprise centric Knowledge Graph.

The system (110) may further determine publisher affinity to the geographic locale. The system (110) may determine the ordered list of language prevalence for a location to the granularity of pin code, city, district, based on user consumption of language specific news articles. The system (110) may attenuate ranking of recommendation for a geographic locale based on language and corresponding publisher affinity. The aforementioned list may be provided, without any change to new users on receiving queried location, determined from GPS or explicit choice against a drop-down list. For existing readers, providing personalized and aggregation of news content, based on category, publisher preference and entities consumed in the past.

In an embodiment, the system (110) may be a System on Chip (SoC) system but not limited to the like. In another embodiment, an onsite data capture, storage, matching, processing, decision-making and actuation logic may be coded using Micro-Services Architecture (MSA) but not limited to it. A plurality of micro-services may be containerized and may be event based in order to support portability.

In an embodiment, the network architecture (100) may be modular and flexible to accommodate any kind of changes in the system (110). The system (110) configuration details can be modified on the fly.

In an embodiment, the system (110) may be remotely monitored and the data, application and physical security of the system (110) may be fully ensured. In an embodiment, the data may get collected meticulously and deposited in a cloud-based data lake to be processed to extract actionable insights. Therefore, the aspect of predictive maintenance can be accomplished.

In an exemplary embodiment, the communication network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. A network may include, by way of example but not limitation, one or more of: a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, some combination thereof.

In another exemplary embodiment, the centralized server (112) may include or comprise, by way of example but not limitation, one or more of: a stand-alone server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof.

In an embodiment, the one or more first computing devices (104), the one or more second computing devices (108) may communicate with the system (110) via set of executable instructions residing on any operating system, including but not limited to, Android™, iOS™, Kai OS™, and the like. In an embodiment, to one or more first computing devices (104), and the one or more second computing devices (108) may include, but not limited to, any electrical, electronic, electro-mechanical or an equipment or a combination of one or more of the above devices such as mobile phone, smartphone, Virtual Reality (VR) devices, Augmented Reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from a user such as touch pad, touch enabled screen, electronic pen, receiving devices for receiving any audio or visual signal in any range of frequencies and transmitting devices that can transmit any audio or visual signal in any range of frequencies. It may be appreciated that the to one or more first computing devices (104), and the one or more second computing devices (108) may not be restricted to the mentioned devices and various other devices may be used. A smart computing device may be one of the appropriate systems for storing data and other private/sensitive information.

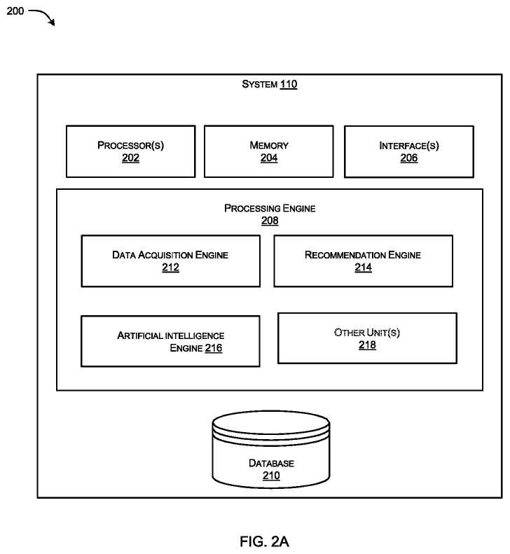

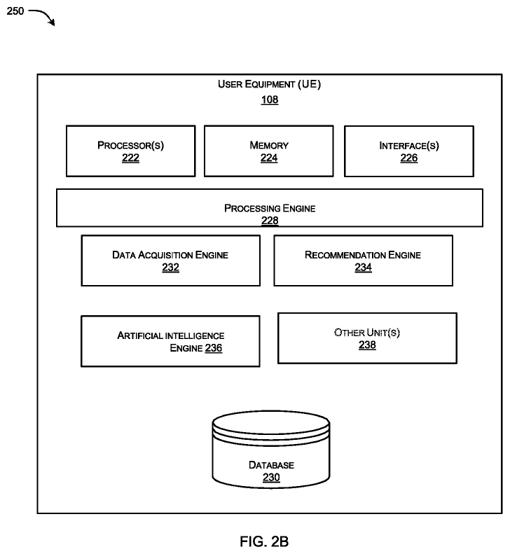

FIG. 2A illustrates an exemplary block diagram representation of proposed system for recommending region specific personalized news, in accordance with an embodiment of the present disclosure. In an aspect, the system (110) may include one or more processor(s) (202). The one or more processor(s) (202) may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (110). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as RAM, or non-volatile memory such as EPROM, flash memory, and the like.

In an embodiment, the system (110) may include an interface(s) 206. The interface(s) (206) may comprise a variety of interfaces, for example, interfaces for data input and output devices, referred to as I/O devices, storage devices, and the like. The interface(s) (206) may facilitate communication of the system (110). The interface(s) (206) may also provide a communication pathway for one or more components of the system (110) or the AI engine (116). Examples of such components include, but are not limited to, processing unit/engine(s) (208) and a database (210).

The processing unit/engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (110) may comprise the machine-readable storage medium storing the instructions and the processing resource to execute the instructions, or the machine-readable storage medium may be separate but accessible to the system (110) and the processing resource. In other examples, the processing engine(s) (208) may be implemented by electronic circuitry.

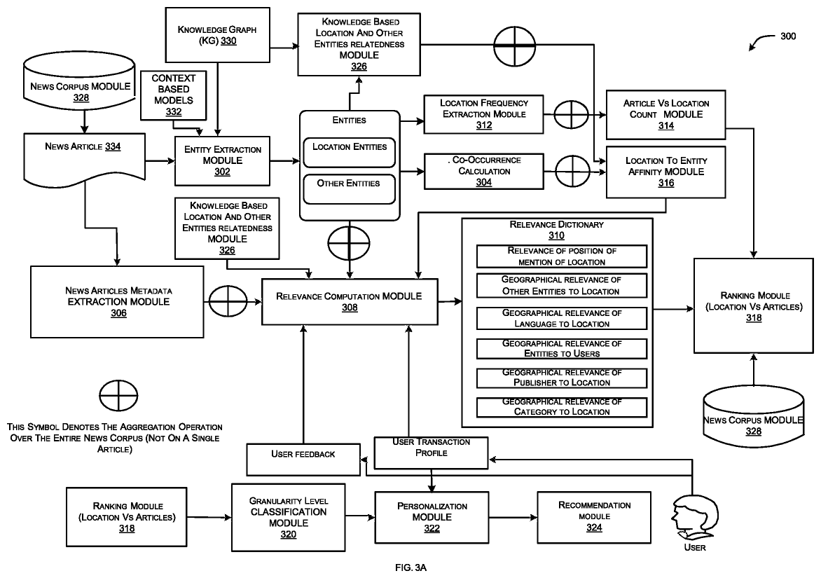

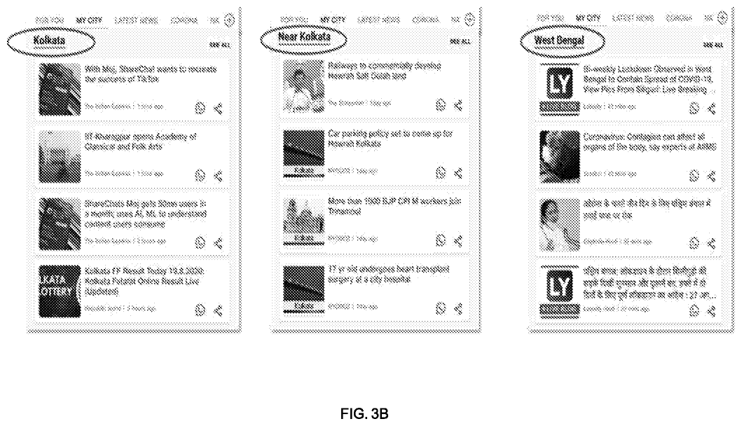

The processing engine (208) may include one or more engines selected from any of a data acquisition engine (212), a recommendation engine (214), an artificial intelligence (AI) engine (216) and other engines (218). The processing engine (208) may further edge based micro service event processing but not limited to the like. The other engines may include a natural language processing engine, a knowledge graph module, a co-occurrence calculation module (304) (Ref, FIG. 3A), a location to entity affinity module (316), a relevance computation module (308), a location frequency extraction module (312), a ranking module (318), a relevance dictionary (310), a granularity level classification module (320), personalization module (322) and the like. A machine learning model for example, but are not limited to, neural networks, support vector machine may be used along with geographical distance metrics to decide the appropriate granularity level, and the like. The aforementioned modules are explained in detail in the following sections.

FIG. 2B illustrates an exemplary representation (250) of the user equipment (UE) (108), in accordance with an embodiment of the present disclosure. In an aspect, the UE (108) may comprise a processor (222). The more processor (222) may be implemented as one or more microprocessors, microcomputers, microcontrollers, digital signal processors, central processing units, logic circuitries, and/or any devices that process data based on operational instructions. Among other capabilities, the processor(s) (222) may be configured to fetch and execute computer-readable instructions stored in a memory (224) of the UE (108). The memory (224) may be configured to store one or more computer-readable instructions or routines in a non-transitory computer readable storage medium, which may be fetched and executed to create or share data packets over a network service. The memory (224) may comprise any non-transitory storage device including, for example, volatile memory such as RAM, or non-volatile memory such as EPROM, flash memory, and the like.

In an embodiment, the UE (108) may include an interface(s) 206. The interface(s) 206 may comprise a variety of interfaces, for example, interfaces for data input and output devices, referred to as I/O devices, storage devices, and the like. The interface(s) 206 may facilitate communication of the UE (108). Examples of such components include, but are not limited to, processing engine(s) 228 and a database (230).

The processing engine(s) (228) may be implemented as a combination of hardware and programming (for example, programmable instructions) to implement one or more functionalities of the processing engine(s) (228). In examples described herein, such combinations of hardware and programming may be implemented in several different ways. For example, the programming for the processing engine(s) (228) may be processor executable instructions stored on a non-transitory machine-readable storage medium and the hardware for the processing engine(s) (228) may comprise a processing resource (for example, one or more processors), to execute such instructions. In the present examples, the machine-readable storage medium may store instructions that, when executed by the processing resource, implement the processing engine(s) (228). In such examples, the UE (108) may comprise the machine-readable storage medium storing the instructions and the processing resource to execute the instructions, or the machine-readable storage medium may be separate but accessible to the UE (108) and the processing resource. In other examples, the processing engine(s) (228) may be implemented by electronic circuitry.

The processing engine (228) may include one or more engines selected from any of a data acquisition engine (232), a recommendation engine (234), an artificial intelligence (AI) engine (236) and other engines (238). The processing engine (228) may further edge based micro service event processing but not limited to the like. The other engines may include a natural language processing engine, a knowledge graph module, a co-occurrence calculation module (304) (Ref, FIG. 3A), a location to entity affinity module (316), a relevance computation module (308), a location frequency extraction module (312), a ranking module (318), a relevance dictionary (310), a granularity level classification module (320), personalization module (322) and the like. A machine learning model for example, but are not limited to, neural networks, support vector machine may be used along with geographical distance metrics to decide the appropriate granularity level, and the like. The aforementioned modules are explained in detail in the following sections.

FIG. 3A illustrates exemplary block diagram representation of a proposed system architecture, in accordance with an embodiment of the present disclosure.

The system architecture (300) may include the news corpus module (328) which aggregates news articles (334) from various publishers in multiple languages.

From a news article (334) a metadata extraction module (306) may extract information like, but not limited to, language, publisher, category, and the like. News article is also inputted to the entity extraction module (302) which extracts entities such as location entities and other entities based on data driven machine learning contextual models (332) and Knowledge Graph (KG) (330). The KG (330) may be a semantic network, which may represent a network of real-world entities such as objects, events, situations, or concepts, and illustrates the relationship between them. This information is usually stored in a graph database and visualized as a graph structure. The KG (330) may store interlinked descriptions of entities of objects, events, situations or abstract concepts and also encodes the semantics. The KG (330) allows to find entities location or others represented in any well-known canonical/surface form, for example (Mumbai/Bombay, City of Joy/Kolkata/Calcutta, Modi/Narendra Modi, Mahi/Dhoni/Mahendra Singh Dhoni). The system architecture (300) may include location and other entities relatedness module (326). Using linkages from the KG (330) such as predicate and attributes depicting relationships with the location, affinity of other entities to a location entity is determined. The KG based and named entity-based relatedness measures may be used to determine the location of news event from a plurality of location mentions.

The system architecture (300) may include a co-occurrence calculation module (304) for corpus wide location entities to other entities co-occurrence calculation. Further, the system architecture (300) may include a location to entity affinity module (316). Ambiguity in determining location associated with the event of the news article from a plurality of locations that may be present in the news articles, may be resolved using meta data such as markers in URL, using attribute and predicate based relationships with other extracted entities extracted from enterprise centric Knowledge Graph and evidence from co-occurrence module.

Further, a relevance computation module (308) which takes inputs from the aforementioned modules, along with user feedback and user profile to generate a relevance dictionary (310) which may include, but are not limited to, relevance of position or location mentioned in text, geographical relevance of other entities to location, geographical relevance of language to location, geographical relevance of entity to users, geographical relevance of publisher to location, geographical relevance of category to location, and the like. For example, user feedback may include, but are not limited to signals which indicate news not relevant to location, does not like particular type/topic of news, news not placed in relevant section of location granularity, news not in priority list, and the like. Further, the system architecture (300) may include a location frequency extraction module (312). The location frequency extraction module (312) may receive the entities extracted from news articles as an input. It calculates the frequency and gives weight based on position of location mentioned in text. The location frequency extraction module (312) may output to article vs location count module (314) which maintains an index of article id vs the weighted count. Further, a ranking module (318) may receive input from the article vs location count module (314) and the relevance dictionary (310), to rank articles for the plurality of locations. It maintains a reverse index of articles ranked for a particular location. Further, the system architecture (300) may include a granularity level classification module (320) for ranked list of articles per location granularity level, which includes but are not limited to, pin code, town, city, state, country, and the like. A machine learning model for example, but are not limited to, neural networks, support vector machine may be used along with geographical distance metrics to decide the appropriate granularity level, and the like. The system architecture (300) may include a personalization module (322) and a recommendation module (324). The personalization module (322) may receive recommendation sorted in different sections from the granularity level classification module (320). A user transaction profile may be inputted to the personalization module (322) that prunes irrelevant recommendations and/or reorders them to output data to the recommendation module (324).

FIG. 3B illustrates an exemplary schematic diagram representation of recommending region specific personalized news, in accordance with an embodiment of the present disclosure. In an instance, every sub-continent may have diverse socio-linguistic groups spread across various locations. Currently the media houses may focus on publishing original content in English predominantly. This creates a sense of alienation among native language speakers. The system (110) may provide content to cater to all sets of users from a variety of languages spanning the length and breadth of the country. The system (110) may display news stories personalised to user's location. The local stories and media shared in local languages may be the basic data of closed group communities. On mining information about entities consumed from the news items and the consumption pattern, businesses can get deep insights to effectively reach their local prospects and cater to linguistic sentiments of the users. The system (110) may provide targeted advertising pertaining to locally popular entities. The information extracted about language and entity affinity to a geographic may also aid in cross domain recommendations. The knowledge may complement businesses in retail verticals as well. FIG. 3B illustrates user interface as ‘My City’ and various curated sections and may also be integrated in ‘pages’ browser.

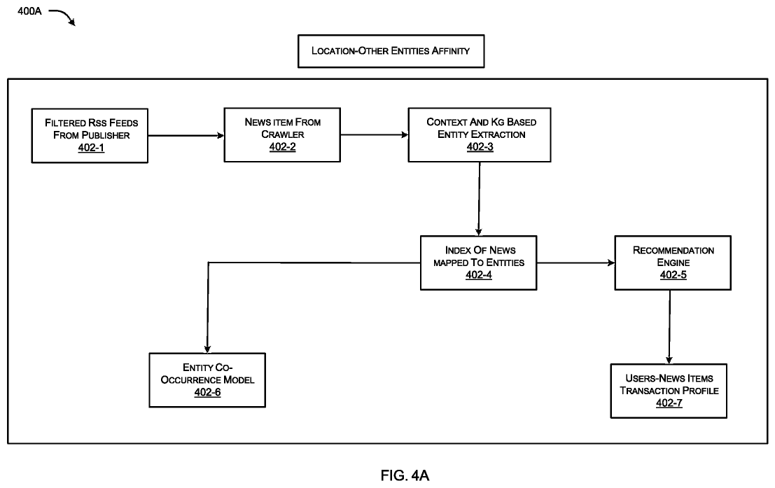

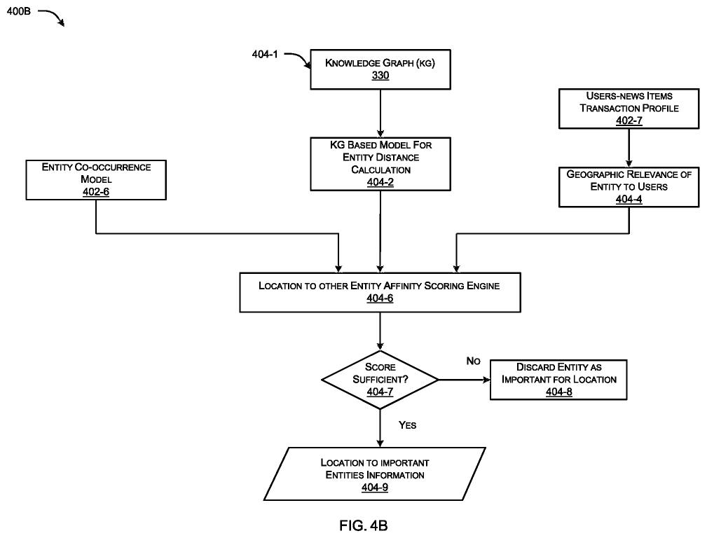

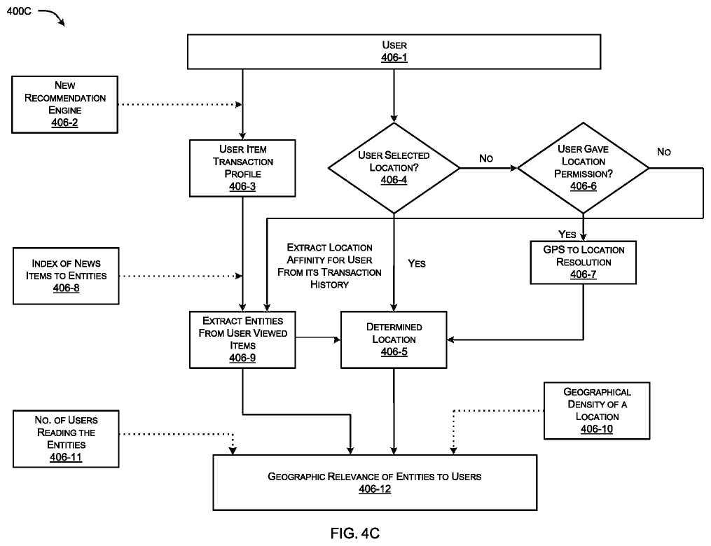

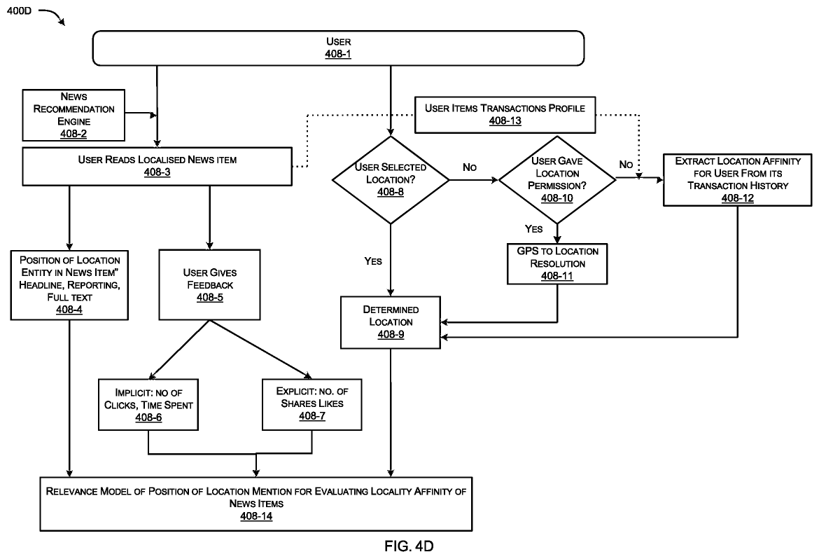

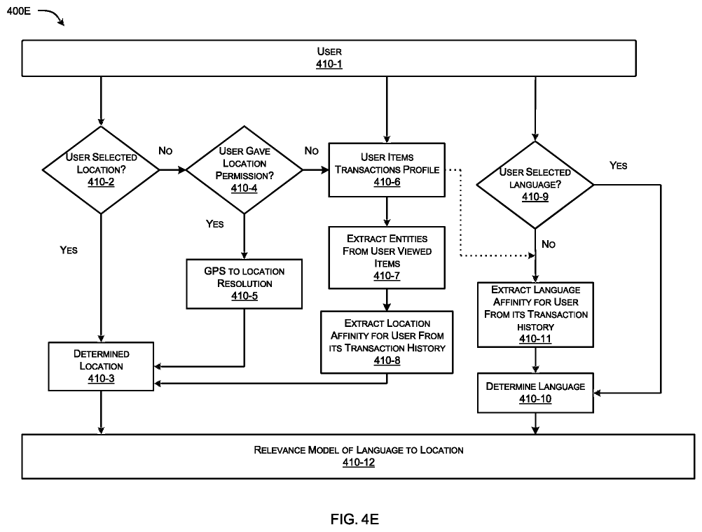

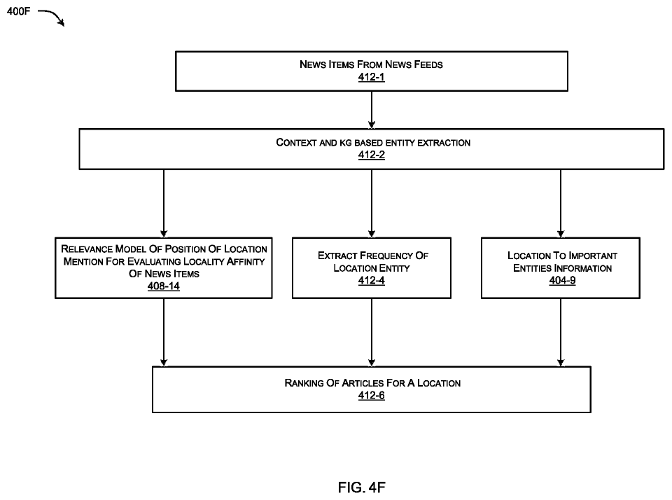

FIGS. 4A and 4B illustrate flow diagram representations of method (400A) and (400B) to determine affinity of other entities to a location entity in phase 1 and phase 2 respectively, in accordance with an embodiment of the present disclosure. FIG. 4A illustrates phase 1 for location to other entity affinity. At step (402-1), filtering RSS feeds from publisher. At step (402-2) obtaining news item from crawler. The crawler may be a line of text of latest news. The news item may be depicted in FIG. 3B. The webpage of the news items in crawled and extraction is done to render a news item which may contain an item id, the headline, full text of the article, summary, publisher name and id, language name and id. It includes as metadata published datetime and updated datetime of the article as an when additional content is added by the publisher. It also contains a network locator or URL, images embedded in the article, image captions, publisher tags etc. At step (402-3), extracting entity based on context and Knowledge Graph (KG) (330). At step (402-4), generating index of news article mapped to entities. At step (402-6), sending data to calculate entity co-occurrences in news articles' content. Entities which occur together frequently are found to be related. At step (402-5) sending data of articles tagged with entities to recommendation engine. At step (402-7) generating transaction profiles of user's basis the consumption of the recommendations. User profile database contains profiles of a plurality of users which may contain information like but not limited to user's id, news item ids read, preferences towards real world entities, preferences towards category of news, time spent reading on the article, rank of the article in the ordered list. It may also contain user's feedback signals like no. of clicks, likes and shares of the content item.

The evidence provided by user transaction profile and feedback is used to determine popularity of entities in a geographic location. FIG. 4B illustrates method 400B in phase 2 for determining location to important entities. At step (404-1) obtaining the Knowledge Graph (KG). At step (404-2), using linkages from Knowledge Graph (KG) (330) such as predicate and attributes depicting relationships of other entities with the location to calculating entity distance. At step (402-7) generating transaction profile of user's basis the consumption of the recommendations from flow chart of FIG. 4A. At step (404-4) using user transaction data to extract entities consumed by users reading different articles from a location to extract geographic relevance of entity to users. At step (402-6), using data from co-occurrences in news articles' content, from the flow chart of FIG. 4A. At step (404-6) using entity co-occurrence model, distance between entities and relevant entities belonging to a location (ascertained by user profiles), a scoring engine generating affinity scores of other entities to a location. At step (404-7) determining, if the scoring is sufficient. If yes, at step (404-9) generating a collection of location to important entities. If no, at step (404-8) discard entity as important for location.

FIG. 4C illustrates a flow diagram representation of method 400C to determine geographic relevance of entities for users, in accordance with an embodiment of the present disclosure.

At step (406-1), presence of user as an actor in the system (300). At step (406-2), a News recommendation engine provides recommendations to users for consumption, with or without any explicit location selection by user. At step (406-3), on interaction between user and the recommendation engine, generating user item transaction profile. At step (406-9), obtaining index of news articles to entities and extracting entities from user viewed items. Independently at step (406-4) determining if the user has selected a location from the list provided in drop down menu for local news interface. If the user has selected, at step (406-5) determining the location and mapping it to the curated location's database entry. If not selected, at step (406-6) determining if user gives location permission. If yes, at step (406-7), executing GPS to location resolution to determine the location. If user does not give location permission, use earlier user profile and entities extracted to establish location preference. At step (406-10), determining geographical density of a location. At step (406-11), determining number of users reading the entities. At step (406-12), using aforementioned blocks to generate a list of geographically relevant entities to users.

FIG. 4D illustrates a flow diagram representation of method (400D) for determining impact of position of location mention in news articles on location importance, in accordance with an embodiment of the present disclosure.

At step (408-1), presence of user as an actor in the system (300). At step (408-8), determining if user has selected location from the list provided in drop down menu. If the user has selected, at step (408-9), determining location and mapping to the database entry. If the user has not selected, at step (408-10), determining if user gives location permission. If yes, at step (408-11), executing GPS to location resolution to determine location. At step (408-2) News recommendation engine provides recommendations to users for consumption independently, with or without any explicit location selection by user. At step (408-3) user reads localized news item and user-item transaction profile is generated. If user does not give location permission, at step (408-12), using user-item transaction profile (408-13) to extract location affinity for users from transaction history. Once the use reads localised news item, at step (408-4), determining position of location entity in news like headline, reporting section or full text. The position of location occurrence and the engagement by users helps to establish relevance and importance of position. At step (408-5), after consumption of recommendations user may provide feedback. For example, user feedback may include, but are not limited to, news not relevant to location, does not like particular type/topic of news, news not placed in relevant section, news not in priority list, and the like. At step (408-6) analysing implicit user feedback like number of clicks, time spent on reading an article etc. At step (408-7), analysing explicit feedback signals like number of shares and likes. At step (408-14), building relevance model of position of location mentions in news item, for evaluating locality affinity of news items.

FIG. 4E illustrates a flow diagram representation of method 400E to determine geographic relevance of a language, in accordance with an embodiment of the present disclosure.

At step (410-1), presence of user as an actor in the system (300). At step (410-2) determining if user has selected location. If yes, at step (410-3), determining location. If no, at step (410-4), determining if user has provided location permission. If yes, at step (410-5), executing GPS to location resolution. If there is no location permission, at step (410-6), using prior user items transaction profile to extract entities from user viewed items (410-7). At (410-8) extract location affinity for user from transaction history. At (410-9) determining if user selected a language. If user has selected language, at step (410-10), determining language. If no language selected, at step (410-11), extracting language affinity for user from the transaction history. At step (410-12), building relevance model of language to selected/preferred location.

FIG. 4F illustrates a flow diagram representation of method 400F to rank articles from a set of candidate articles for a given location, in accordance with an embodiment of the present disclosure.

At step (412-1), obtaining news items from news feeds. At step (412-2) determining context-KG based location and other entities extraction. At step (408-14) from flow chart of FIG. 4D, obtaining relevance model of position of location mention for evaluating locality affinity of news items. At step (412-4), extracting frequency of location entity. At step (404-9), determining location to important entities information from flow chart of FIG. 4B. At step (412-6), using the aforementioned modules for ranking of articles for a location.

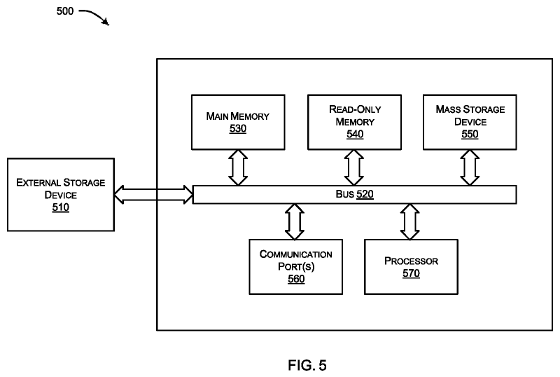

FIG. 5 illustrates an exemplary computer system (500) in which or with which embodiments of the present invention can be utilized in accordance with embodiments of the present disclosure. As shown in FIG. 5, computer system (500) can include an external storage device (510), a bus (520), a main memory (530), a read only memory (540), a mass storage device (550), communication port (560), and a processor (570). A person skilled in the art will appreciate that the computer system may include more than one processor and communication ports. Processor (570) may include various modules associated with embodiments of the present invention. Communication port (560) may be chosen depending on a network to which computer system connects. Memory (530) can be Random Access Memory (RAM), or any other dynamic storage device commonly known in the art. Read-only memory (540) can be any static storage device(s). Mass storage (550) may be any current or future mass storage solution, which can be used to store information and/or instructions.

Bus (520) communicatively couples' processor(s) (570) with the other memory, storage and communication blocks. Bus (520) can be used for connecting expansion cards, drives and other subsystems as well as other buses, such a front side bus (FSB), which connects processor 570 to software system.

Optionally, operator and administrative interfaces, e.g., a display, keyboard, and a cursor control device, may also be coupled to bus (520) to support direct operator interaction with a computer system. Other operator and administrative interfaces can be provided through network connections connected through communication port 560. Components described above are meant only to exemplify various possibilities. In no way should the aforementioned exemplary computer system limit the scope of the present disclosure.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

A portion of the disclosure of this patent document contains material which is subject to intellectual property rights such as, but are not limited to, copyright, design, trademark, IC layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### ADVANTAGES OF THE PRESENT DISCLOSURE

The present disclosure provides methods and systems for recommending region specific personalized news.

The present disclosure provides tagging of news articles as local to a geographic location.

The present disclosure is to enable named entity tagging and Knowledge Graph (KG) based relatedness measures to determine the location of news event from a plurality of location mentions.

The present disclosure uses Knowledge Graph (KG) to find location and other entities (such as city, person and the like) using canonical/surface form.

The present disclosure provides methods and systems for determining location importance to news article based on position of mention in text and user feedback.

The present disclosure enables language and publishers as factors to decide local importance of news articles.

The present disclosure provides methods and systems to recommend local news in a plethora of subcontinent/local languages catering to linguistic and community sentiment.

The present disclosure provides personalised local news content according to deep analysis of user profile.

We claim:

1. A system (110) for recommending region specific personalized news, said system (110) comprising;
one or more processors (202) operatively coupled to a plurality of first computing devices (104), the one or more processors (202) coupled with a memory (204), wherein said memory (204) stores instructions which when executed by the one or more processors (202) causes said system (110) to:
receive one or more content inputs from the plurality of first computing devices (104), the one or more content inputs pertaining to one or more news articles;
receive a plurality of user inputs from the plurality of first computing devices (104), the plurality of user inputs pertaining to interest of the plurality of users with the one or more news articles;
extract a first set of attributes from the received one or more content inputs, the first set of attributes pertaining to one or more contextual parameters associated with the one or more content inputs;
extract a second set of attributes from the received one or more content inputs, the second set of attributes pertaining to geographical location associated with the one or more contextual parameters;
extract a third set of attributes from the received one or more content inputs, the third set of attributes pertaining to language of the one or more articles associated with the plurality of news;
based on the extracted first, second, third set of attributes and the received plurality of user inputs, determine, a locality sensitivity score to each said news article;
rank, the one or more content inputs in an ordered list based on the locality sensitivity score; and, auto-recommend, the ordered list to a plurality of users associated with the plurality of first computing devices (104).

2. The system as claimed in claim 1, wherein the one or more contextual parameters comprise granular details of a location, language, category, topic, publisher preference, preferred entities such as popular people associated with the one or more news articles.

3. The system as claimed in claim 1, wherein the system is further configured to determine a publisher affinity to a geographic location associated with the one or more news articles.

4. The system as claimed in claim 1, wherein the system is further configured to determine, by a knowledge graph module, the ordered list based on a language, predicate, attribute, prevalence of a location, the location comprising a granularity of pin code, city, district based on user consumption of language specific news articles.

5. The system as claimed in claim 3, wherein the system is further configured to attenuate ranking of the ordered list for a geographic locale based on language and the publisher affinity, wherein the ordered list is provided, without any change to one or more new users on receiving queried location from one or more first computing devices associated with the one or more new users.

6. The system as claimed in claim 3, wherein the system is further configured to personalise the ordered list to one or more existing users based on an existing user transaction data associated with a user profile received from one or more first computing devices associated with the one or more existing users.

7. The system as claimed in claim 3, wherein the system is further configured to determine geographic relevance of the one or more news articles that is being read in a location by a plurality of users.

8. The system as claimed in claim 3, wherein the system is further configured to determine impact of position of location in the one or more news articles on importance of the one or more news articles, and further determine if said article is local to a location, is of national importance or needs international coverage.

9. The system as claimed in claim 3, wherein the system is further configured to generate one or more news articles pertaining to a specific geographic location based on the received plurality of user inputs associated with the specific geographic location.

10. The system as claimed in claim 3, wherein the system is further configured to:
resolve ambiguity in determining location associated with an event of the news article from a plurality of locations that are present in the news articles;
prune one or more irrelevant recommended one or more content inputs and reorder the one or more content inputs to the ordered list.

11. A user equipment (UE) (108) for recommending region specific personalized news, said UE (108) comprising;
a processor (222) and a receiver operatively coupled to a plurality of first computing devices (104), the processor (222) coupled with a memory (224), wherein said memory (224) stores instructions which when executed by the processors (222) causes said UE (108) to:
receive, by the receiver, one or more content inputs from the plurality of first computing devices (104), the one or more content inputs pertaining to one or more news articles;
receive a plurality of user inputs from the plurality of first computing devices (104), the plurality of user inputs pertaining to interest of the plurality of users with the one or more news articles;
extract a first set of attributes from the received one or more content inputs, the first set of attributes pertaining to one or more contextual parameters associated with the one or more content inputs;
extract a second set of attributes from the received one or more content inputs, the second set of attributes pertaining to geographical location associated with the one or more contextual parameters;
extract a third set of attributes from the received one or more content inputs, the third set of attributes pertaining to language of the one or more articles associated with the plurality of news;
based on the extracted first, second, third set of attributes and the received plurality of user inputs, determine, a locality sensitivity score to each said news article;
rank, the one or more content inputs in an ordered list based on the locality sensitivity score; and,
auto-recommend, the ordered list to a plurality of users associated with the plurality of first computing devices (104).

12. A method for recommending region specific personalized news, said method comprising;
receiving, by one or more processors (202), one or more content inputs from the plurality of first computing devices (104), the one or more content inputs pertaining to one or more news articles, wherein the one or more processors (202) are operatively coupled to a plurality of computing devices (104), the one or more processors (202) coupled with a memory (204), wherein said memory (204) stores instructions executed by the one or more processors (202);
receiving, by the one or more processors (202), a plurality of user inputs from the plurality of first computing devices (104), the plurality of user inputs pertaining to interest of the plurality of users with the one or more news articles;
extracting, by the one or more processors (202), a first set of attributes from the received one or more content inputs, the first set of attributes pertaining to one or more contextual parameters associated with the one or more content inputs;
extracting, by the one or more processors (202), a second set of attributes from the received one or more content inputs, the second set of attributes pertaining to geographical location associated with the one or more contextual parameters;
extracting, by the one or more processors (202), a third set of attributes from the received one or more content inputs, the third set of attributes pertaining to language of the one or more articles associated with the plurality of news;
based on the extracted first, second, third set of attributes and the received plurality of user inputs, determining, by the one or more processors (202), a locality sensitivity score to each said news article;
ranking, by the one or more processors (202), the one or more content inputs in an ordered list based on the locality sensitivity score; and,
auto-recommend, by the one or more processors (202), the ordered list to a plurality of users associated with the plurality of computing devices (104).

13. The method as claimed in claim 12, wherein the one or more contextual parameters comprise granular details of a location, language, category, topic, publisher preference, preferred entities such as popular people associated with the one or more news articles.

14. The method as claimed in claim 12, wherein the method further comprises the step of determining, by the one or more processors, a publisher affinity to a geographic location associated with the one or more news articles.

15. The method as claimed in claim 12, wherein the method further comprises the step of determining, by a knowledge graph module, the ordered list based on a language, predicate, attribute, prevalence of a location, the location comprising a granularity of pin code, city, district based on user consumption of language specific news articles.

16. The method as claimed in claim 14, wherein the method further comprises the step of attenuating, by the one or more processors, ranking of the ordered list for a geographic locale based on language and the publisher affinity, wherein the ordered list is provided, without any change to one or more new users on receiving queried location from one or more computing devices associated with the one or more new users.

17. The method as claimed in claim 14, wherein the method further comprises the step of personalising, by the one or more processors, the ordered list to one or more existing users based on an existing user transaction data associated with a user profile received from one or more computing devices associated with the one or more existing users.

18. The method as claimed in claim 14, wherein the method further comprises the step of determining geographic relevance of the one or more news articles that is being read in a location by a plurality of users.

19. The method as claimed in claim 14, wherein the method further comprises the step of determining, by the one or more processors, impact of position of location in the one or more news articles on importance of the one or more news articles, and further determine if said article is local to a location, is of national importance or needs international coverage.

20. The method as claimed in claim 14, wherein the method further comprises the step of generating, by the one or more processors, one or more news articles pertaining to a specific geographic location based on the received plurality of user inputs associated with the specific geographic location.

21. The method as claimed in claim 3, wherein the method further comprises the steps of:
resolving ambiguity, by the one or more processors (202), in determining location associated with an event of the news article from a plurality of locations that are present in the news articles;
prune, by the one or more processors (202), one or more irrelevant recommended one or more content inputs and reorder the one or more content inputs to the ordered list.
